(19) United States
(12) Patent Application Publication
(10) Pub. No.: US 2025/0291082 A1
(43) Pub. Date: Sep. 18, 2025

(54) CROSS-CORRELATION FILTER FOR DISTRIBUTED ACOUSTIC SENSING SYSTEM FOR WELLBORE

(71) Applicant: Halliburton Energy Services, Inc., Houston, TX (US)

(72) Inventors: Aleksandar Jeremic, Houston, TX (US); Werner Heigl, Fulshear, TX (US); Mikko K. Jaaskelainen, Houston, TX (US)

(21) Appl. No.: 18/603,938

(22) Filed: Mar. 13, 2024

(51) Int. Cl. G01V 1/36; E21B 43/26; G01V 1/22

(52) U.S. Cl. CPC G01V 1/366; G01H 9/004; E21B 47/00

(57) ABSTRACT

A system can include a distributed acoustic sensing (DAS) system and a computing device coupled with the DAS system. The DAS system can include a pulse generator and a sensing fiber that can be positioned in a wellbore. The system can generate a light pulse to be transmitted into the sensing fiber to make one or more measurements relating to a wellbore operation involving the wellbore. The system can receive an initial pulse that includes a reflection of the light pulse prior to the light pulse entering the sensing fiber. The system can apply a cross-correlation filter to one or more subsequently received pulse reflections originating from the sensing fiber. The cross-correlation filter can include the initial pulse reflection or synthetic initial pulse. The system can generate, based on applying the cross-correlation filter, an output signal that can be used to control the wellbore operation.

### TECHNICAL FIELD

The present disclosure relates generally to wellbore operations and, more particularly (although not necessarily exclusively), to a filter for a downhole distributed acoustic sensing (DAS) system that can use cross-correlation to enhance a signal-to-noise ratio (SNR).

### BACKGROUND

Wellbore operations may include various equipment, components, methods, or techniques to produce material, inject material, transport material using a wellbore, flowline, or other pipeline. In some examples, the wellbore operations may include or otherwise use a distributed acoustic sensing (DAS) system to monitor the wellbore operations or for other suitable purposes. The DAS system may detect environmental conditions, fluid conditions, and the like via acoustic signals. But, the signals received by the DAS system may include excessive amounts of noise that may render controlling the wellbore operations difficult.

### BRIEF DESCRIPTION OF THE DRAWINGS

FIG. 1 is a simplified diagram of a wellbore system that includes a distributed acoustic sensing (DAS) system that can use a cross-correlation filter to enhance a signal-to-noise ratio (SNR) of DAS signals generated based on a wellbore according to one example of the present disclosure.

FIG. 2 is a block diagram of a computing device that can be used to filter a data by cross-correlation acquired by DAS system according to one example of the present disclosure.

FIG. 3 is a simplified flow diagram of a DAS system that includes a reflective surface and that can use a cross-correlation filter to enhance an SNR of DAS signals according to one example of the present disclosure.

FIG. 4 is a flowchart of a process to generate DAS signals by applying a cross-correlation filter including an initial pulse reflection using a DAS system according to one example of the present disclosure.

FIG. 5 is a flowchart of a process to generate DAS signals by applying a cross-correlation filter including a synthetic initial pulse using a DAS system according to one example of the present disclosure.

### DETAILED DESCRIPTION

Certain aspects and examples of the present disclosure relate to a distributed acoustic sensing (DAS) system that can use a cross-correlation filter to generate DAS signals about a wellbore operation involving a wellbore. The wellbore may be formed in a subterranean formation, a sub-oceanic formation, or the like to extract material such as oil, gas, water, or the like. The wellbore operation may be or include a wellbore drilling operation, a wellbore completion operation, a wellbore stimulation operation, a wellbore production operation, or the like. In some examples, the wellbore operation may involve measuring one or more parameters about the wellbore operation or the wellbore. The one or more parameters may include environmental parameters (e.g., temperature, pressure, etc.), fluid flow parameters (e.g., viscosity, flow velocity, etc.), and the like. The one or more parameters can be measure by the DAS system, for example via acoustic signals or fiber optic signals. The DAS system can use the cross-correlation filter that can include an initial pulse, which may be directly (or indirectly) measured or may be estimated as a synthetic initial pulse, to perform one or more cross-correlation operations. The one or more cross-correlation operations may enhance, for example by reducing noise or increasing signal, a signal-to-noise ratio (SNR) of the DAS signals generated by the DAS system.

DAS systems, such as other DAS systems or other data acquisition systems, can be affected by noise while acquiring data. The data acquired by the DAS systems can be used in many applications for many different industries. The applications can utilize the DAS data to perform diagnostics, to perform monitoring, to estimate a model based on some inversion schemes, to perform other operations, or any combination thereof. For example, and with respect to the oil and gas industry, the following can be estimated using the DAS systems: microseismic location, microseismic magnitude or focal mechanism, fracture geometry (e.g., length, height, azimuth), fracture opening or closing mechanisms, and the like. The estimations can be used to make decisions to control a wellbore operation such as a fracturing operation.

An inversion application, or other suitable applications that involve DAS signals, can be sensitive to the noise in data, and uncertainty of application results or estimation can be directly proportional to the signal-to-noise ratio (SNR). The smaller the SNR, the larger the uncertainty in prediction. The larger the uncertainty in prediction, the worse the process decision that may be made.

The SNR can influence other aspects of the DAS systems. For example, the light pulse generated by the DAS systems can attenuate, for example at approximately 0.2 dB/km, while propagating through a sensing fiber. At some point along an extended-length sensing fiber, the light pulse, or the signal, may be weaker than a noise level. Thus, certain regions of the sensing fiber may have very low SNR, which may produce data having uncertain results. By improving SNR, the sensing fiber length can be increased for various applications or wellbore operations. For example, and with respect to subsea applications, a longer sensing fiber (e.g., compared to other systems) can be used if the SNR is improved over an SNR of other systems.

For DAS signals or related data, the noise can be divided internal noise and external noise. In some examples, internal noise can be generated within an acquisition apparatus, the sensing fiber, the DAS system, or any combination thereof. The internal noise may be universal and may affect the uncertainty of the results for all applications. Additionally or alternatively, the external noise can include strain sources not accounted for or otherwise explained by models of the DAS system. The external noise may vary with the application, and in some examples, the signal for one of the applications may be the noise for the another. The external noise may be treated individually such that each application treats a de-noising process differently.

A DAS system that uses or otherwise facilitates cross-correlation can be used to improve (e.g., compared to other DAS systems) SNR caused by internal sources. The DAS system can yield better model estimations or results with less uncertainty and a better ability to acquire data with longer sensing fiber lengths. The DAS system can make or allow better decisions for controlling a wellbore operation.

In some examples, the DAS system can enhance the SNR of DAS signals by using a filtering approach. The DAS system can measures a relative phase of two points along a sensing fiber disposed in a wellbore or otherwise positioned for facilitating DAS measurements. The two points may be separated by a distance, which may be or include a gauge length. Using the relative phase at consecutive time samples, a strain change can be estimated along the gauge length for the time period. The strain change can be or include input for the DAS system, for example for applications such as a microseismic application, a strain analysis, and the like. The DAS system can involve or perform operations involving transmitting a light pulse through the sensing fiber. The sensing fiber may include scatterers, which can cause the light pulses to reflect back, and the reflected light pulses may carry information of the state (e.g., mechanical or deformational) of the sensing fiber. The returning signal can be a superposition of the light pulses, which may be or include an optical shot. Due to the random nature of the scatterers, the optical shot can be considered random.

The optical shot can be delayed by a time proportional to the gauge length to estimate the relative phase between two points along the fiber in time separated by the gauge length. The optical shot can be a time function, and the time function can be decomposed into amplitude and phase, which can create an analytical signal. In some examples, the relative phase can be the phase difference between an original optical shot and a delayed optical shot, and the difference can give a certain measure of mechanical state of the sensing fiber between the points separated by the gauge length. Due to the random nature of scattering, the relative phase may also be random. In some examples, the relative phase may be extracted outside of the optical domain. Some operations for extracting the relative phase can include demodulation, photodetection, digitization, and the like. Demodulation may include a process in which original and delayed optical shots are manipulated such that light carrier frequency is removed, and at the same time, the relative phase information is preserved. Additionally or alternatively, the optical shots, or derivatives thereof, can be converted to an electrical current or voltage using a photodetector and then can be digitized by an analog-to-digital converter. An I-value (in-phase component) and a Q-value (quadrature component) can be estimated from the optical shot, and the relative phase can be determined using the I-value and the Q-value. For example, the relative phase (φ) can be determined by:

$$φ ∝ {tan}^{- 1} \frac{Q}{I} \qquad Equation 1$$

In some examples, phase-sensitive DAS interrogator systems can operate via phase measurement of Rayleigh backscatter from the sensing fiber. For example, a laser can emit one or more light pulses at a user-configurable rate into the sensing fiber. Within a receiver arm, backscattered light from two distinct locations along the sensing fiber can be mixed together via a compensating interferometer. This can result in the in-phase (I) and quadrature (Q) interference signals, which express the phase difference of the light between two locations, a distance called the gauge length, along the sensing fiber.

In some examples, and after converting the I and Q optical signals into analog electrical signals, and passing the signals through an analog-to-digital converter at a typical sampling rate (e.g., 100 MHz) via a digitizer card installed in a server, the arctangent of the I and Q components can be calculated. The arctangent operation can yield a phase measurement that is proportional to the relative strain over the gauge length. Assuming a refractive index of the sensing fiber of approximately 1.5, the above-discussed sampling rate of the analog-to-digital converter can result in a spatial sampling interval of the digitized DAS data of approximately one m. By measuring amplitude, frequency, and phase of the relative strain data along the fiber at short gauge lengths (e.g., 5 m), a real-time acoustic log every 1 m along the length of the fiber can be produced. Various processing techniques can be applied to each particular attribute to yield a wide variety of answer products for applications such as sand control, flow assurance, well integrity, downhole equipment integrity, and microseismic event location.

Since the relative phase is a relative measure, and since the scatterers may be random, the DAS system can transmit a subsequent light pulse into the sensing fiber. If there are mechanical changes along the sensing fiber, physical properties thereof may be changed, which can cause a change in relative phase. A difference between two consecutive relative phases can be or include a delta phase or a dphase. The dphase can be linearly proportional to the strain changes experienced during the time between the two optical shots, or the time samples, and between two points separated by the gauge length.

The DAS system can use a filter that can be applied to each optical shot, or any subset thereof. The DAS system can use the filter to maximize the light pulse signal and to minimize the noise, which may be or include energy not related to the light pulse. The filter can be applied in optical domain, for example before demodulation, photodetection, digitization, or any combination thereof. In some examples, the filter can be applied in the digital domain, such as after digitization, and on the I-values and the Q-values. In some examples, the light pulse can be or include the filter that can be applied by the DAS system. An I-Q frequency spectrum can be conditioned by photo-detected and digitized pulses. Applying the pulse filter on I-values and Q-values (e.g., IQ data) can cause the filter weight to scale the frequencies of the data proportional to amplitude or power. Additionally or alternatively, the filter can zero out the frequencies in examples in which there is no IQ data. Thus, the filter can maximize the SNR.

In some examples, and to perform the filtering, the pulse P can be determined. Determining the pulse can involve estimating the pulse, such as determining a synthetic initial pulse, or measuring the pulse such as directly measuring an initial pulse reflection. To estimate the synthetic initial pulse, the DAS system can be used. The DAS system can be designed to produce a pulse of a certain length, and the pulse can follow the design properties of the designed pulse. Different pulse settings may be selected based on system characteristics. For example, and based at least in part on the system characteristics, which can include a length of the sensing fiber, an expected optical attenuation, etc., the pulse length, the pulse amplitude, the pulse energy, the pulse shape, and other pulse settings may be selected. The longer pulse length, the higher pulse energy, etc. may be selected when the measured event locations are further away from the sensing fiber, and the pulse length may be adjusted over time if or as needed, In addition, the shorter the pulse length, the higher spatial resolution is. The synthetic initial pulse can be estimated based at least in part on the pulse settings selected.

In some examples, the initial pulse can be measured such as directly measured. For example, the DAS system can directly measure the initial pulse reflection by installing an optical component, such as a reflection device, that can allow the transmitted light pulse to be demodulated, photodetected, and digitized. The pulse settings may also be adjusted to yield specific pulse characteristics associated with specific applications. To measure the initial pulse reflection, one or more additions can be made to the DAS system. Once the pulse is transmitted towards the sensing fiber and passes a switcher, which can control whether the pulse is transmitted to the sensing fiber or directed towards a recording unit, a coupler can split light into two paths. Most of the energy can be directed along a first path into the sensing fiber, while remaining portions of the energy can be directed to acquire the initial pulse reflection, which may be or include a near-perfect reflection of the pulse transmitted into the sensing fiber. Acquiring the initial pulse reflection can be achieved by placing a reflective surface, such as a mirror, at an initial end of the sensing fiber to reflect the pulse back to the recording system.

Once the synthetic initial pulse is determined or the initial pulse reflection is measured, the filter can be applied. In some examples, the filter can be applied in the digital domain. Additionally or alternatively, the output from the interrogator can be digitized at approximately 100 MHz or more. Once the data is provided to a computer system from the interrogator, the IQ data can be filtered or otherwise processed. For example, the filtered data (I_{f}, Q_{f}) may be or include cross-correlation in a time domain or complex-conjugate multiplication in a frequency domain (*) of the I-value data and the Q-value data (I_{d}, Q_{d}) of reflected data with the photodetected and digitized pulse, P (Equation 2, below). The scaling of the filter may not affect estimating the dphase or strain change, as the dphase can be a function of a Q-I ratio (Equation 1), both having the same scale from the filter. The filtered ID data can be processed to estimate the dphase data.

$${I}_{f} = {I}_{d} * P ; {Q}_{f} = {Q}_{d} * P \qquad Equation 2$$

The DAS system that uses the filter involving the initial pulse reflection, or the synthetic initial pulse, with cross-correlation can improve various applications. For example, and with respect to microseismic analysis, more accurate detections can be made, and weaker events can be identified compared to other DAS systems. In particular, a more accurate detection, location, and characterization of microseismic events can be made or determined using the DAS system. Additionally or alternatively, weaker microseismic events can be identified since the SNR associated with the DAS system is higher than the SNR for other DAS systems. In examples relating to low-frequency strain analysis, the DAS system (i) can yield more accurate hydraulic fracture geometry and mechanism characteristics than the other DAS systems and (ii) can identify weaker fractures and smaller low-frequency strain changes than other DAS systems.

These illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

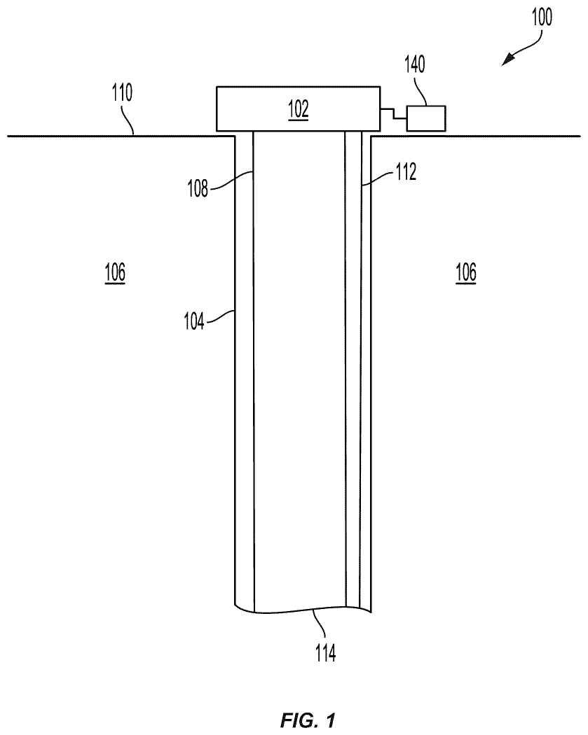

FIG. 1 is a simplified diagram of a wellbore system 100 that includes a distributed acoustic sensing (DAS) system 102 that can use a cross-correlation filter to enhance a signal-to-noise ratio (SNR) of DAS signals generated based on a wellbore 104 according to one example of the present disclosure. As illustrated in FIG. 1, the wellbore 104 can be formed or otherwise positioned in a subterranean formation 106. In other examples, the wellbore 104 may be formed or otherwise positioned in a sub-oceanic formation or in other suitable locations for the wellbore 104. The wellbore 104 may be formed in the subterranean formation 106 to extract material, such as oil, gas, water, or the like, from the subterranean formation 106 or for other suitable purposes. A casing 108 may be positioned in the wellbore 104 to facilitate operations, such as stimulation operations (e.g., hydraulic fracturing), production operations, and the like, with respect to the wellbore 104. In other examples, and alternative to the casing 108, one or more strings, such as completion strings, production strings, and the like, can be positioned in the wellbore 104 to facilitate the operations.

As illustrated in FIG. 1, the DAS system 102 can be positioned at a surface 110 of the wellbore 104 or the subterranean formation 106, though, in other examples, the DAS system 102 can be positioned in other suitable locations such as at least partially remotely, at least partially downhole in the wellbore 104, or the like. The DAS system 102 can include one or more internal components, such as an interrogator, a pulse generator, a reflective surface, a coupler, and the like, and the DAS system 102 can include one or more external components such as a sensing fiber 112. In some examples, the sensing fiber 112 can be or include a fiber optic cable, an acoustic cable, other suitable types of conduit, or any combination thereof that can receive and transmit signals from the DAS system 102. The sensing fiber 112 can be positioned in the wellbore 104 to facilitate communication in the wellbore 104, to facilitate measurements about, or within, the wellbore 104, and the like. For example, and as illustrated in FIG. 1, the sensing fiber 112 can be coupled with the DAS system 102 and can extend from the surface 110 to a bottom 114 of the wellbore 104, though any other suitable length for the sensing fiber 112 is possible.

The DAS system 102 can be used to make measurements with an enhanced SNR compared to other DAS systems. For example, the DAS system 102 can use a cross-correlation filter, which may include, or may involve applying, an initial pulse, and the like to enhance signal and suppress noise in DAS signals received by the DAS system 102. The DAS signals may be generated or otherwise caused by the DAS system 102 to make one or more measurements with respect to the wellbore 104. For example, the DAS system 102 can generate light pulses or other signals that can be used to measure a strain or other characteristics about the sensing fiber 112, which may indicate characteristics about microseismic activity, fracturing operations, or the like. Additionally or alternatively, the DAS system 102 can be communicatively coupled with a computing device 140 that can be used to apply the cross-correlation filter, to perform cross-correlation operations, or to perform other suitable operations with respect to the DAS system 102. In some examples, alternative to being communicatively coupled with the computing device 140, the DAS system 102 can include or be included in the computing device 140.

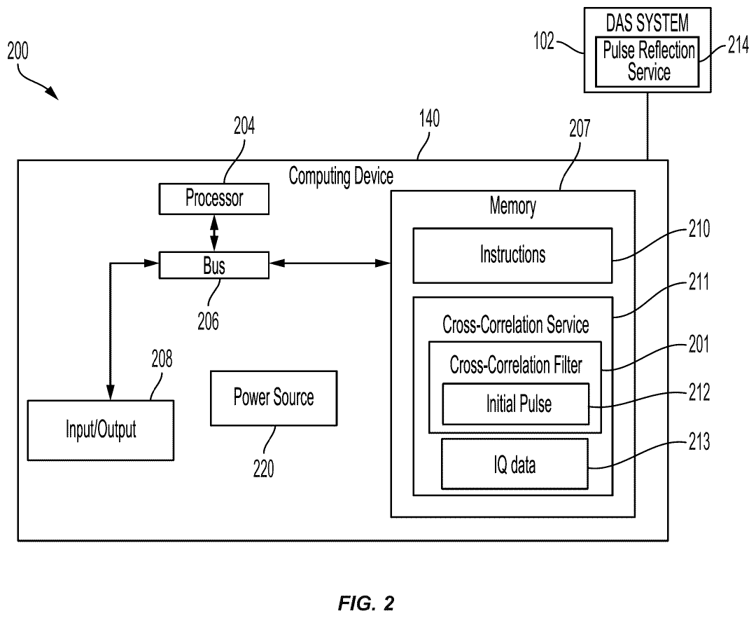

FIG. 2 is a block diagram of a computing device 140 that can be used to perform cross-correlation with a cross-correlation filter 201 with respect to a DAS system 102 according to one example of the present disclosure. The components, such as processor 204, memory 207, power source 220, input/output 208, and the like, illustrated in FIG. 2 may be integrated into a single structure such as within a single housing of the computing device 140 and in communication with the DAS system 102. In some examples, the components illustrated in FIG. 2 can be distributed from one another and may be in electrical communication with each other. And, in other examples, the DAS system 102 may be included in the computing device 140 or vice versa.

The computing device 140 can include the processor 204, the memory 207, and a bus 206, among other suitable components for the computing device 140. The processor 204 can execute one or more operations for performing cross-correlation, such as by applying the cross-correlation filter 201, or other DAS-based operations on data signals received with respect to a wellbore operation involving the wellbore 104. The processor 204 can execute computer-program instructions 210 stored in the memory 207 to perform the operations. The processor 204 can include one processing device or multiple processing devices or cores. Non-limiting examples of the processor 204 can include a field-programmable gate array (“FPGA”), an application-specific integrated circuit (“ASIC”), a microprocessor, and the like.

The processor 204 can be communicatively coupled with the memory 207 via the bus 206. The memory 207 may be or include non-volatile memory and may include any type of memory device that retains stored information when powered off. Some examples of non-volatile forms of the memory 207 may include EEPROM, flash memory, or any other type of non-volatile memory. In some examples, at least part of the memory 207 can include a medium from which the processor 204 can read computer-program instructions 210. A computer-readable medium can include electronic, optical, magnetic, or other storage devices capable of providing the processor 204 with computer-readable instructions or other program code. Some examples of a computer-readable medium may include magnetic disk(s), memory chip(s), ROM, RAM, an ASIC, a configured processor, optical storage, or any other medium from which a computer processor can read computer-program instructions 210. The computer-program instructions 210 can include processor-specific instructions generated by a compiler or an interpreter from code written in any suitable computer-programming language, including, for example, C, C++, C#, Perl, Java, Python, etc.

In some examples, the memory 207 can be a non-transitory computer readable medium and can include computer-program instructions 210. The computer-program instructions 210 can be executed by the processor 204 for causing the processor 204 to perform various operations. For example, the processor 204 can execute a cross-correlation service 211, and the like to provide functionality for the computing device 140, the DAS system 102, or the like. The pulse reflection service 214 can be executed to determine an initial pulse 212. For example, the processor 204 can (i) determine a synthetic initial pulse, or (ii) use an initial pulse reflection to be measured by the DAS system 102. The initial pulse 212, whether synthetic or measured, can be used via the cross-correlation service 211 to enhance signal and suppress noise in the DAS signals received by the DAS system 102. For example, the processor 204 can execute the cross-correlation service 211 to apply the cross-correlation filter 201, which can include the initial pulse 212, to IQ data 213 to enhance the signal and to suppress the noise. In some examples, IQ data 213 may include I-value data and Q-value data from reflected pulses originating from the sensing fiber 112.

The computing device 140 can additionally include an input/output 208. The input/output 208 can connect to a keyboard, a pointing device, a display, other computer input/output devices or any combination thereof. An operator may provide input using the input/output 208. Data relating to the wellbore 104, equipment thereof (e.g., the DAS system 102), the wellbore operation, or any combination thereof can be displayed to an operator of a wellbore operation through a display that is connected to or is part of the input/output 208. The displayed values can be observed by the operator, or by another suitable user, of the wellbore operation, who can adjust the wellbore operation based on the output. Additionally or alternatively, the computing device 140 can automatically control or adjust the wellbore operation, which may be or include a fracturing operation, based on the output.

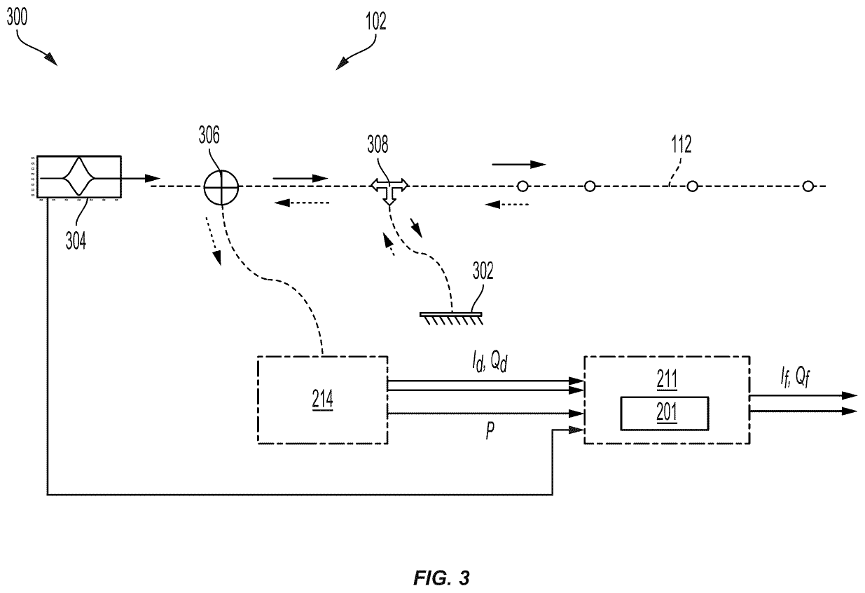

FIG. 3 is a simplified flow diagram 300 of a DAS system 102 that includes a reflective surface 302 and that can use a cross-correlation filter 201 to enhance an SNR of DAS signals according to one example of the present disclosure. As illustrated in the simplified flow diagram 300, the DAS system 102 can include a pulse generator 304, a circulator 306, a coupler 308, the reflective surface 302, the sensing fiber, the pulse reflection service 214, and the cross-correlation service 211 that can include the cross-correlation filter 201, though the DAS system 102 can include any additional or alternative components, services, or the like. In some examples, the cross-correlation service 211, the pulse reflection service 214, any component or service thereof, or a combination thereof may be included in the computing device 140, which may be included in or otherwise communicatively coupled with the DAS system 102.

The pulse generator 304 can be used to generate one or more light pulses. For example, the pulse generator 304, such as via the computing device 140, can be used to generate a light pulse having predetermined pulse characteristics such as a pulse amplitude, a pulse energy, a pulse shape, and the like. The pulse generator 304 can generate the light pulse and can propagate the light pulse to the circulator 306, which can further propagate the light pulse to the coupler 308. The coupler 308 may further propagate the light pulse into the sensing fiber 112 to cause reflected pulses to be generated and transmitted back to the coupler 308, the circulator 306, other components of the DAS system 102, or the like. In some examples, the coupler 308 can split at least a portion of the light pulse and transmit the portion of the light pulse to the reflective surface 302. The coupler 308 may be controlled by the pulse reflection service 214, by the computing device 140, by other suitable components of the DAS system 102, or any combination thereof. Controlling the coupler 308 may involve determining whether, or how much, to split the portion of the light pulse to be transmitted to the reflective surface 302.

The reflective surface 302 may be or include a mirror or other suitable reflective surface that can generate a near-perfect reflection of the light pulse. In some examples, a near-perfect reflection of the light pulse may be or include an initial pulse reflection that may have characteristics (e.g., amplitude, shape, etc.) that are similar (e.g., within about 5%, within about 105, within about 20%, etc.) or identical to characteristics of the originally generated light pulse. The reflective surface 302 can reflect the initial pulse reflection to the coupler 308 and back to the circulator 306. The circulator 306 may additionally or alternatively receive reflected pulses from the sensing fiber 112, and the reflected pulses may include or otherwise indicate I-values and Q-values (e.g., the IQ data) that may be used to generate signals, such as an output signal or DAS signals, that can be used to characterize the wellbore 104, an operation involving the wellbore 104, the sensing fiber 112, and the like.

The initial pulse reflection and the one or more pulse reflections can be transmitted to the pulse reflection service 214, which may be or include a hardware component of the DAS system 102 and that can be used to extract the IQ data from the one or more pulse reflections and to determine the initial pulse reflection data. For example, the pulse reflection service 214 can receive the measured initial pulse reflection from the reflective surface 302 and the reflected pulses from the sensing fiber 112, and the pulse reflection service 214 can delay, demodulate, photodetect, and digitize the received pulses, etc. In other examples, the pulse reflection service 214 can be provided with the pulse characteristics for the light pulse generated by the pulse generator 304, and the pulse reflection service 214 or the cross-correlation service 211 can estimate a synthetic initial pulse based at least in part on the pulse characteristics. Additionally or alternatively, the pulse reflection service 214 can extract the IQ data from the reflected pulses. The pulse reflection service 214 can transmit the initial pulse reflection, P, and the raw IQ data, I_{d}, Q_{d}, to the cross-correlation service 211.

The cross-correlation service 211 can use the initial pulse reflection and the raw IQ data and can perform a cross-correlation operation, for example using the cross-correlation filter 201, to generate filtered IQ data, I_{f}, Q_{f}. For example, the cross-correlation service 211 can use each of the equations represented by Equation 2 to generate the filtered IQ data by applying the cross-correlation filter 201, which may be or include the initial pulse reflection, to the IQ data. The cross-correlation service 211 can use any other or additional operations or computations to cross-correlate the initial pulse reflection and the raw IQ data to generate the filtered IQ data. In some examples, the filtered IQ data can be output by the cross-correlation service 211 to be post-processed or to otherwise undergo additional processing or operations to generate one or more DAS signals. For example, the filtered IQ data can be used to estimate or otherwise determine the dphase of the initial pulse reflection and the one or more reflected pulses. Additionally or alternatively, the filtered IQ data, or the dphase, can be used to determine or estimate a strain on the sensing fiber 112, and the strain can be used to determine microseismic activity, fracturing activity, fluid flow properties, and the like.

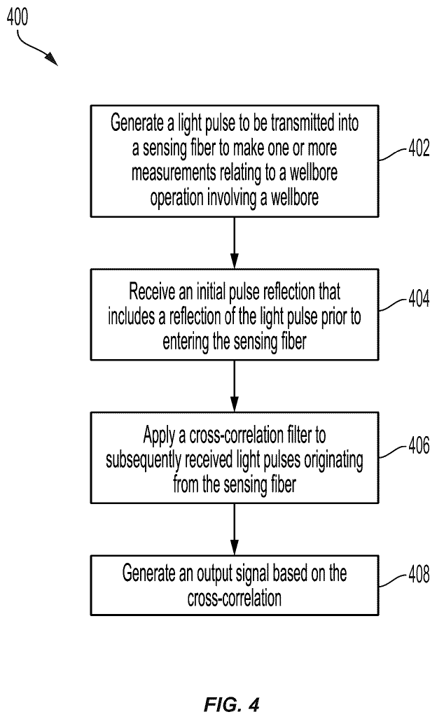

FIG. 4 is a flowchart of a process 400 to generate DAS signals by applying a cross-correlation filter including an initial pulse reflection using a DAS system 102 according to one example of the present disclosure. At block 402, a light pulse is generated. The light pulse may be generated by the DAS system 102 or any component thereof such as the pulse generator 304. The light pulse may be generated to have one or more pulse characteristics such as a pulse amplitude, a pulse energy, a pulse shape, and the like. The light pulse can be generated and propagated into a sensing fiber 112 of the DAS system 102, and the sensing fiber 112 can be positioned in a wellbore 104. In some examples, the DAS system 102 can include other components, such as internal components (e.g., the circulator 306, the coupler 308, etc.), that can facilitate propagation of the light pulse. The light pulse may be generated and at least partially propagated, such as via the sensing fiber 112, into the wellbore 104 to make one or more measurements about one or more wellbore operations involving the wellbore 104 or about the wellbore 104. In some examples, the one or more wellbore operations may include a wellbore stimulation operation (e.g., a fracturing operation), a wellbore production operation, or the like.

At block 404, an initial pulse reflection is received. The initial pulse reflection may be or include a measured initial pulse reflection. In some examples, at least a portion of the light pulse may be directed (e.g., via the coupler 308) to a reflective surface 302 instead of the sensing fiber 112, and the reflective surface 302 may reflect the portion of the light pulse away from the sensing fiber 112 and to the DAS system 102 or any component thereof such as the circulator 306. The DAS system 102, or any component thereof, can measure or otherwise receive the reflected portion of the light pulse as the measured initial pulse reflection. In some examples, the initial pulse reflection may be a near-perfect reflection of the light pulse. For example, the initial pulse reflection may have similar or identical pulse characteristics, such as a pulse amplitude, a pulse shape, a pulse phase, etc., as the originally generated light pulse.

At block 406, the initial pulse reflection and one or more subsequently received pulse reflections originating from the sensing fiber 112 are cross-correlated using a cross-correlation filter 201. The one or more subsequently received pulse reflections may be reflections of the light pulse generated by the light pulse reflecting off of one or more junctions or other portions of the sensing fiber 112. The initial pulse reflection, which may be or include the measured initial pulse reflection, can be provided to the cross-correlation service 211, and the cross-correlation service 211 can additionally receive IQ data about the one or more subsequently received pulse reflections. In some examples, the initial pulse reflection may be or be included in the cross-correlation filter 201. The IQ data may include I-value data points, Q-value data points, or a combination thereof. The I-value data points may be or include in-phase components of the one or more subsequently received pulse reflections, and the Q-value data points may be or include quadrature components of the one or more subsequently received pulse reflections.

In some examples, cross-correlating the initial pulse reflection and the one or more subsequently received pulse reflections can involve applying the cross-correlation filter 201 to the IQ data, which may be or include raw IQ data. The cross-correlation filter 201 may be or include the initial pulse reflection. For example, the cross-correlation service 211 may apply the initial pulse reflection to the raw IQ data to generate filtered IQ data. Applying the initial pulse reflection to the raw IQ data may involve cross-correlating the initial pulse reflection with the raw IQ data to generate the filtered IQ data.

In some examples, the cross-correlating operation involving the cross-correlation filter 201, the one or more subsequently received pulse reflections, and the like can involve sampling the one or more subsequently received pulse reflections. Sampling the pulse reflections may involve selecting a subset of the pulse reflections, applying the cross-correlation filter 201 in response to receiving a threshold number of pulse reflections, or the like. For example, an odd number of pulse reflections may be sampled or otherwise used to perform the cross-correlation. In other examples, an even number of pulse reflections may be sampled or otherwise used to perform the cross-correlation.

At block 408, an output signal is generated for controlling the wellbore operation. In some examples, the output signal may be or include a DAS signal that can be generated based at least in part on the filtered IQ data. The filtered IQ data can be used to estimate a dphase that can be used to determine a strain on the sensing fiber 112. The strain on the sensing fiber 112 can indicate microseismic activity, fracturing activity, fluid flow properties, or the like. The output signal can be used to control the wellbore operation by adjusting one or more parameters that may be used to control the wellbore operation. In a particular example in which the wellbore operation is a wellbore stimulation operation, such as a hydraulic fracturing operation, the output signal can be used to determine a change to a volume or rate of fracturing fluid to inject via the wellbore to control the wellbore operation. In another such example, the output signal can indicate that microseismic activity exceeds a threshold and can be used to decrease a volume or rate of fracturing fluid to inject.

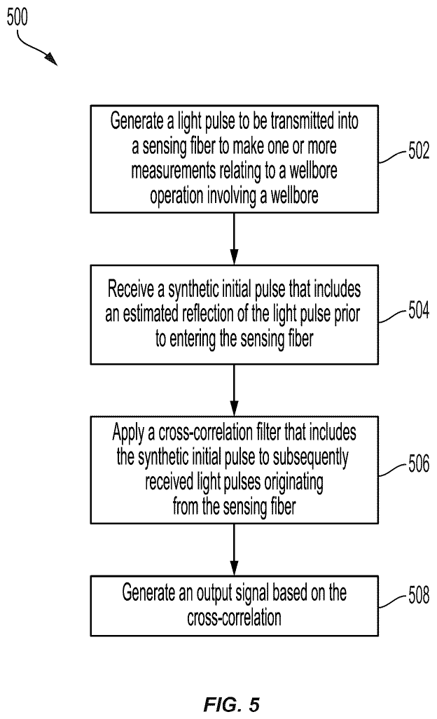

FIG. 5 is a flowchart of a process 500 to generate DAS signals by applying a cross-correlation filter 201 including a synthetic initial pulse using a DAS system 102 according to one example of the present disclosure. At block 502, a light pulse is generated. The light pulse may be generated by the DAS system 102 or any component thereof such as the pulse generator 304. The light pulse may be generated to have one or more pulse characteristics such as a pulse amplitude, a pulse energy, a pulse shape, and the like. The light pulse can be generated and propagated into a sensing fiber 112 of the DAS system 102, and the sensing fiber 112 can be positioned in a wellbore 104. In some examples, the DAS system 102 can include other components, such as internal components (e.g., the circulator 306, the coupler 308, etc.), that can facilitate propagation of the light pulse. The light pulse may be generated and at least partially propagated, such as via the sensing fiber 112, into the wellbore 104 to make one or more measurements about one or more wellbore operations involving the wellbore 104 or about the wellbore 104. In some examples, the one or more wellbore operations may include a wellbore stimulation operation (e.g., a fracturing operation), a wellbore production operation, or the like.

At block 504, an initial pulse is received. The initial pulse may be or include a synthetic initial pulse. In some examples, the synthetic initial pulse may be a near-perfect to the light pulse from the pulse generator 304. For example, the synthetic initial pulse may have similar or identical pulse characteristics, such as a pulse amplitude, a pulse shape, a pulse phase, etc., as the originally generated light pulse from the pulse generator 304. In some examples, the synthetic initial pulse may be estimated or otherwise generated by the cross-correlation service 211, the computing device 140, other components thereof, or any combination thereof. For example, the pulse reflection service 214 may determine the originally generated pulse and may provide the pulse characteristics of the originally generated pulse to the cross-correlation service 211, or any other suitable component of the computing device 140, to estimate the synthetic initial pulse.

At block 506, the synthetic initial pulse and one or more subsequently received pulse reflections originating from the sensing fiber 112 are cross-correlated. The one or more subsequently received pulse reflections may be reflections of the light pulse generated by the light pulse reflecting off of one or more junctions or other portions of the sensing fiber 112. The initial pulse, which may be or include the synthetic initial pulse, can be provided to the cross-correlation service 211, and the cross-correlation service 211 can additionally receive IQ data about the one or more subsequently received pulse reflections. The IQ data may include I-value data points, Q-value data points, or a combination thereof. The I-value data points may be or include in-phase components of the one or more subsequently received pulse reflections, and the Q-value data points may be or include quadrature components of the one or more subsequently received pulse reflections.

In some examples, cross-correlating the synthetic initial pulse and the one or more subsequently received pulse reflections can involve applying the cross-correlation filter 201 to the IQ data, which may be or include raw IQ data. The cross-correlation filter 201 may be or include the synthetic initial pulse. For example, the cross-correlation service 211 may apply the synthetic initial pulse to the raw IQ data to generate filtered IQ data. Applying the synthetic initial pulse to the raw IQ data may involve cross-correlating the synthetic initial pulse with the raw IQ data to generate the filtered IQ data.

At block 508, an output signal is generated for controlling the wellbore operation. In some examples, the output signal may be or include a DAS signal that can be generated based at least in part on the filtered IQ data. The filtered IQ data can be used to estimate a dphase that can be used to determine a strain on the sensing fiber 112. The strain on the sensing fiber 112 can indicate microseismic activity, fracturing activity, fluid flow properties, or the like. The output signal can be used to control the wellbore operation by adjusting one or more parameters that may be used to control the wellbore operation. In a particular example in which the wellbore operation is a wellbore stimulation operation, such as a hydraulic fracturing operation, the output signal can be used to determine a change to a volume or rate of fracturing fluid to inject via the wellbore to control the wellbore operation. In another such example, the output signal can indicate that microseismic activity exceeds a threshold and can be used to decrease a volume or rate of fracturing fluid to inject.

In some aspects, systems and methods for a cross-correlation filter for a distributed acoustic sensing (DAS) system are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a system comprising: a distributed acoustic sensing (DAS) system that includes a pulse generator and a sensing fiber positionable in a wellbore; a processor; and a non-transitory computer-readable medium that includes instructions executable by the processor for causing the processor to perform operations comprising: generating, using the pulse generator, a light pulse to be transmitted into the sensing fiber to make one or more measurements relating to a wellbore operation involving the wellbore; receiving an initial pulse that includes a reflection of the light pulse prior to the light pulse entering the sensing fiber; applying a cross-correlation filter to one or more subsequently received pulse reflections originating from the sensing fiber, the cross-correlation filter comprising the initial pulse; and generating, based on applying the cross-correlation filter, an output signal usable to control the wellbore operation.

Example 2 is the system of example 1, wherein the operation of receiving the initial pulse comprises generating a synthetic light pulse that is an estimated initial pulse reflection, and wherein the operation of applying the cross-correlation filter to the one or more subsequently received pulse reflections comprises cross-correlating the synthetic light pulse and the one or more subsequently received pulse reflections.

Example 3 is the system of example 1, wherein the operation of receiving the initial pulse comprises measuring an initial pulse reflection from a reflective surface positionable between the pulse generator and the sensing fiber.

Example 4 is the system of example 1, wherein the operation of applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

Example 5 is the system of any of examples 1 or 4, wherein the operation of applying the cross-correlation filter to the one or more subsequently received pulse reflections comprises: cross-correlating the raw I-value with the initial pulse to generate a filtered I-value; and cross-correlating the raw Q-value with the initial pulse to generate a filtered Q-value.

Example 6 is the system of any of examples 1 or 4-5, wherein the operation of generating the output signal comprises estimating a delta phase (dphase) of the generated light pulse using the filtered I-value and the filtered Q-value to generate the output signal.

Example 7 is the system of example 1, wherein the operation of applying the cross-correlation filter to the one or more subsequently received pulse reflections comprises: determining whether to sample the subsequently received pulse reflections with an odd number or with an even number; and sampling the odd number or the even number of the subsequently received pulse reflections of the one or more subsequently received pulse reflections.

Example 8 is a method comprising: generating, by a computing system communicatively coupled with a distributed acoustic sensing (DAS) system that includes a pulse generator and a sensing fiber positioned in a wellbore, a light pulse to be transmitted into the sensing fiber to make one or more measurements relating to a wellbore operation involving the wellbore; receiving, by the computing system, an initial pulse that includes a reflection of the light pulse prior to the light pulse entering the sensing fiber; applying, by the computing system, a cross-correlation filter to one or more subsequently received pulse reflections originating from the sensing fiber, the cross-correlation filter comprising the initial pulse; and generating, by the computing system and based applying the cross-correlation filter to the one or more subsequently received pulse reflections, an output signal for controlling the wellbore operation.

Example 9 is the method of example 8, wherein receiving the initial pulse comprises generating a synthetic light pulse that is an expected initial pulse reflection, and wherein applying the cross-correlation filter to the one or more subsequently received pulse reflections comprises cross-correlating the synthetic light pulse and the one or more subsequently received pulse reflections.

Example 10 is the method of example 8, wherein receiving the initial pulse comprises measuring an initial pulse reflection from a reflective surface positioned between the pulse generator and the sensing fiber.

Example 11 is the method of example 8, wherein applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

Example 12 is the method of any of examples 8 or 11, wherein applying the cross-correlation filter to the one or more subsequently received pulse reflections comprises: cross-correlating the raw I-value with the initial pulse to generate a filtered I-value; and cross-correlating the raw Q-value with the initial pulse to generate a filtered Q-value.

Example 13 is the method of any of examples 8 or 11-12, wherein generating the output signal comprises estimating a delta phase (dphase) of the generated light pulse using the filtered I-value and the filtered Q-value to generate the output signal.

Example 14 is the method of example 8, wherein applying the cross-correlation filter to the one or more subsequently received pulse reflections comprises: determining whether to sample the subsequently received pulse reflections with an odd number or with an even number; and sampling the odd number or the even number of the subsequently received pulse reflections of the one or more subsequently received pulse reflections.

Example 15 is a system comprising: a distributed acoustic sensing (DAS) system comprising: a pulse generator to generate one or more light pulses; a sensing fiber positionable in a wellbore to facilitate one or more measurements about the wellbore; and a reflective surface positionable between the pulse generator and the sensing fiber to reflect at least a portion of the one or more light pulses; a processor; and a non-transitory computer-readable medium that includes instructions executable by the processor for causing the processor to perform operations comprising: generating, using the pulse generator, a particular light pulse to be transmitted into the sensing fiber to make one or more measurements relating to a wellbore operation involving the wellbore; receiving, by reflecting at least a portion of the particular light pulse from the reflective surface prior to the particular light pulse entering the sensing fiber, an initial pulse; applying a cross-correlation filter to one or more subsequently received pulse reflections originating from the sensing fiber, the cross-correlation filter comprising the initial pulse; and generating, based on applying the cross-correlation filter to the one or more subsequently received pulse reflections, an output signal usable to control the wellbore operation.

Example 16 is the system of example 15, wherein the operation of applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

Example 17 is the system of any of examples 15-16, wherein the operation of applying the cross-correlation filter to the one or more subsequently received pulse reflections comprises: cross-correlating the raw I-value with the initial pulse to generate a filtered I-value; and cross-correlating the raw Q-value with the initial pulse to generate a filtered Q-value.

Example 18 is the system of any of examples 15-17, wherein the operation of generating the output signal comprises estimating a delta phase (dphase) of the generated light pulse using the filtered I-value and the filtered Q-value to generate the output signal.

Example 19 is the system of example 15, wherein the operation of applying the cross-correlation filter to the one or more subsequently received pulse reflections comprises: determining whether to sample the subsequently received pulse reflections with an odd number or with an even number; and sampling the odd number or the even number of the subsequently received pulse reflections of the one or more subsequently received pulse reflections.

Example 20 is the system of example 15, wherein the wellbore operation comprises a fracturing operation, and wherein the operations further comprise adjusting a fracture parameter to control the fracturing operation.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a distributed acoustic sensing (DAS) system that includes a pulse generator and a sensing fiber positionable in a wellbore;
a processor; and
a non-transitory computer-readable medium that includes instructions executable by the processor for causing the processor to perform operations comprising:
generating, using the pulse generator, a light pulse to be transmitted into the sensing fiber to make one or more measurements relating to a wellbore operation involving the wellbore;
receiving an initial pulse that includes a reflection of the light pulse prior to the light pulse entering the sensing fiber;
applying a cross-correlation filter to one or more subsequently received pulse reflections originating from the sensing fiber, the cross-correlation filter comprising the initial pulse; and
generating, based on applying the cross-correlation filter, an output signal usable to control the wellbore operation.

2. The system of claim 1, wherein the operation of receiving the initial pulse comprises generating a synthetic light pulse that is an estimated initial pulse reflection, and wherein the operation of applying the cross-correlation filter to the one or more subsequently received pulse reflections comprises cross-correlating the synthetic light pulse and the one or more subsequently received pulse reflections.

3. The system of claim 1, wherein the operation of receiving the initial pulse comprises measuring an initial pulse reflection from a reflective surface positionable between the pulse generator and the sensing fiber.

4. The system of claim 1, wherein the operation of applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

5. The system of claim 4, wherein the operation of applying the cross-correlation filter to the one or more subsequently received pulse reflections comprises:
cross-correlating the raw I-value with the initial pulse to generate a filtered I-value; and
cross-correlating the raw Q-value with the initial pulse to generate a filtered Q-value.

6. The system of claim 5, wherein the operation of generating the output signal comprises estimating a delta phase (dphase) of the generated light pulse using the filtered I-value and the filtered Q-value to generate the output signal.

7. The system of claim 1, wherein the operation of applying the cross-correlation filter to the one or more subsequently received pulse reflections comprises:
determining whether to sample the subsequently received pulse reflections with an odd number or with an even number; and
sampling the odd number or the even number of the subsequently received pulse reflections of the one or more subsequently received pulse reflections.

8. A method comprising:
generating, by a computing system communicatively coupled with a distributed acoustic sensing (DAS) system that includes a pulse generator and a sensing fiber positioned in a wellbore, a light pulse to be transmitted into the sensing fiber to make one or more measurements relating to a wellbore operation involving the wellbore;
receiving, by the computing system, an initial pulse that includes a reflection of the light pulse prior to the light pulse entering the sensing fiber;
applying, by the computing system, a cross-correlation filter to one or more subsequently received pulse reflections originating from the sensing fiber, the cross-correlation filter comprising the initial pulse; and
generating, by the computing system and based applying the cross-correlation filter to the one or more subsequently received pulse reflections, an output signal for controlling the wellbore operation.

9. The method of claim 8, wherein receiving the initial pulse comprises generating a synthetic light pulse that is an expected initial pulse reflection, and wherein applying the cross-correlation filter to the one or more subsequently received pulse reflections comprises cross-correlating the synthetic light pulse and the one or more subsequently received pulse reflections.

10. The method of claim 8, wherein receiving the initial pulse comprises measuring an initial pulse reflection from a reflective surface positioned between the pulse generator and the sensing fiber.

11. The method of claim 8, wherein applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

12. The method of claim 11, wherein applying the cross-correlation filter to the one or more subsequently received pulse reflections comprises:
cross-correlating the raw I-value with the initial pulse to generate a filtered I-value; and
cross-correlating the raw Q-value with the initial pulse to generate a filtered Q-value.

13. The method of claim 12, wherein generating the output signal comprises estimating a delta phase (dphase) of the generated light pulse using the filtered I-value and the filtered Q-value to generate the output signal.

14. The method of claim 8, wherein applying the cross-correlation filter to the one or more subsequently received pulse reflections comprises:
determining whether to sample the subsequently received pulse reflections with an odd number or with an even number; and
sampling the odd number or the even number of the subsequently received pulse reflections of the one or more subsequently received pulse reflections.

15. A system comprising:
a distributed acoustic sensing (DAS) system comprising:
a pulse generator to generate one or more light pulses;
a sensing fiber positionable in a wellbore to facilitate one or more measurements about the wellbore; and
a reflective surface positionable between the pulse generator and the sensing fiber to reflect at least a portion of the one or more light pulses;
a processor; and
a non-transitory computer-readable medium that includes instructions executable by the processor for causing the processor to perform operations comprising:
generating, using the pulse generator, a particular light pulse to be transmitted into the sensing fiber to make one or more measurements relating to a wellbore operation involving the wellbore;
receiving, by reflecting at least a portion of the particular light pulse from the reflective surface prior to the particular light pulse entering the sensing fiber, an initial pulse;
applying a cross-correlation filter to one or more subsequently received pulse reflections originating from the sensing fiber, the cross-correlation filter comprising the initial pulse; and
generating, based on applying the cross-correlation filter to the one or more subsequently received pulse reflections, an output signal usable to control the wellbore operation.

16. The system of claim 15, wherein the operation of applying the cross-correlation filter to the one or more subsequently received pulse reflections comprises (i) isolating a raw I-value of the one or more subsequently received pulse reflections and (ii) isolating a raw Q-value of the one or more subsequently received pulse reflections.

17. The system of claim 16, wherein the operation of applying the cross-correlation filter to the one or more subsequently received pulse reflections comprises:
cross-correlating the raw I-value with the initial pulse to generate a filtered I-value; and
cross-correlating the raw Q-value with the initial pulse to generate a filtered Q-value.

18. The system of claim 17, wherein the operation of generating the output signal comprises estimating a delta phase (dphase) of the generated light pulse using the filtered I-value and the filtered Q-value to generate the output signal.

19. The system of claim 15, wherein the operation of applying the cross-correlation filter to the one or more subsequently received pulse reflections comprises:
determining whether to sample the subsequently received pulse reflections with an odd number or with an even number; and
sampling the odd number or the even number of the subsequently received pulse reflections of the one or more subsequently received pulse reflections.

20. The system of claim 15, wherein the wellbore operation comprises a fracturing operation, and wherein the operations further comprise adjusting a fracture parameter to control the fracturing operation.
